(19) United States
(12) Patent Application Publication
(10) Pub. No.: US 2025/0273140 A1
(43) Pub. Date: Aug. 28, 2025

(54) OPTICAL COMPENSATION SYSTEM AND METHOD

(71) Applicant: LG Display Co., Ltd., Seoul (KR)

(72) Inventor: Jung Ha KIM, Paju-si (KR)

(21) Appl. No.: 18/819,460

(22) Filed: Aug. 29, 2024

(30) Foreign Application Priority Data
Feb. 26, 2024 (KR) 10-2024-0027415

(51) Int. Cl. G09G 3/3233

(52) U.S. Cl. CPC G09G 3/3233; G09G 2300/0842; G09G 2320/0238; G09G 2320/0247; G09G 2320/041; G09G 2320/0626

(57) ABSTRACT

An optical compensation system includes a display device including a plurality of pixels, a first measurement unit configured to measure optical characteristics from an image displayed in a first area of the display device, a second measurement unit configured to measure optical characteristics from an image displayed in a second area of the display device, a driver configured to control at least one of the data voltage, the high voltage, and the low voltage of the display device to display an image, and a controller configured to detect a first low voltage optimized for pixels in the first area and a second low voltage optimized for pixels in the second area and to detect optical compensation values based on an image displayed by supplying the first low voltage to the pixels in the first area and supplying the second low voltage to the pixels in the second area.

### CROSS-REFERENCE TO RELATED APPLICATION(S)

This application claims the benefit of Korean Patent Application No. 10-2024-0027415, filed on Feb. 26, 2024, which is hereby incorporated by reference as if fully set forth herein.

### BACKGROUND

### Technical Field

The present disclosure relates to an optical compensation system and method.

### Description of the Related Art

As the information society develops, the demand for displays is increasing in various forms, and in response to this, various flat panel display devices with characteristics such as compactness, light weight, and low power consumption, such as a liquid crystal display, a plasma display panel, and an organic light emitting diode display are being studied.

Display device manufacturing processes include a process of manufacturing a display panel, a test process for the completed display panel, etc. During the test process, by detecting and analyzing defects in the completed display panel, the defects can be repaired or reworked to improve overall yield.

### BRIEF SUMMARY

The disclosure is directed to techniques for accurately detecting and compensating for defects in a display panel being tested. The present disclosure provides an optical compensation system and method that substantially obviate one or more problems due to limitations and disadvantages of the related art.

The present disclosure provides an optical compensation system and method capable of improving compensation accuracy during optical compensation of a display panel.

Additional improvements, technical characteristics, and features of the present disclosure will be set forth in part in the description which follows and in part will become apparent to those having ordinary skill in the art upon examination of the following or may be learned from practice of the present disclosure. The objectives and other advantages of the present disclosure may be realized and attained by the structure particularly pointed out in the written description and claims hereof as well as the appended drawings.

To achieve these technical features, characteristics, and other improvements and in accordance with the purpose of the present disclosure, as embodied and broadly described herein, an optical compensation system includes a display device including a plurality of pixels configured to emit light by controlling a driving current flowing from a high voltage to a low voltage according to a data voltage, a first measurement unit configured to measure optical characteristics from an image displayed in a first area of the display device, a second measurement unit configured to measure optical characteristics from an image displayed in a second area of the display device, a driver configured to control at least one of the data voltage, the high voltage, and the low voltage of the display device to display an image, and a controller configured to detect a first low voltage optimized for pixels in the first area and a second low voltage optimized for pixels in the second area on the basis of optical characteristics input to the first measurement unit and the second measurement unit and to detect optical compensation values on the basis of an image displayed by supplying the first low voltage to the pixels in the first area and by supplying the second low voltage to the pixels in the second area.

The first area may include a general area having a general subpixel arrangement, and the second area may include an optical area in which a transmission part for an optical device is formed.

The controller may detect black data values expressed by supplying the first low voltage to the pixels in the first area and supplying the second low voltage to the pixels in the second area, and then detect optical compensation values of the first area and the second area.

The controller may supply a fixed data voltage to the first area and the second area, adjust the low voltage applied to the first area and the low voltage applied to the second area, and detect low voltages at which preset luminance is measured in the areas as the first low voltage and the second low voltage.

The controller may detect the optical compensation values by setting an initialization voltage (VAR) of the first area on the basis of the first low voltage and setting an initialization voltage (VAR) of the second area on the basis of the second low voltage.

The controller may detect the optical compensation values of the first area and the second area by generating a first low voltage profile according to the temperature and luminance of the first area on the basis of the first low voltage and generating a second low voltage profile according to the temperature and luminance of the second area on the basis of the second low voltage.

The controller may store the optical compensation values in an internal memory of the display device through the driver.

The second area may include an optical area in which a transmission part for an optical device is formed, and the second measurement unit may have an aperture small enough to measure optical characteristics of the second area.

In another aspect of the present disclosure, an optical compensation method for a display device including a plurality of pixels configured to emit light by controlling a driving current flowing from a high voltage to a low voltage according to a data voltage includes measuring optical characteristics of a first area having a general subpixel arrangement in the display device through a first measurement unit, and simultaneously measuring optical characteristics of a second area including an optical area through a second measurement unit, detecting a first low voltage optimized for pixels in the first area and a second low voltage optimized for pixels in the second area on the basis of optical characteristics input to the first measurement unit and the second measurement unit, and detecting optical compensation values on the basis of an image displayed by supplying the first low voltage to the pixels in the first area and supplying the second low voltage to the pixels in the second area.

The optical compensation method may further include detecting black data values expressed by supplying the first low voltage to the pixels in the first area and supplying the second low voltage to the pixels in the second area.

The detecting a first low voltage optimized for pixels in the first area and a second low voltage optimized for pixels in the second area may include supplying a fixed data voltage to the first area and the second area, adjusting the low voltage applied to the first area and the low voltage applied to the second area, and detecting low voltages at which preset luminance is measured in the areas as the first low voltage and the second low voltage.

The optical compensation method may include detecting the optical compensation values by setting an initialization voltage (VAR) of the first area on the basis of the first low voltage and setting an initialization voltage (VAR) of the second area on the basis of the second low voltage.

The detecting optical compensation values on the basis of an image displayed by supplying the first low voltage to the pixels in the first area and supplying the second low voltage to the pixels in the second area may include detecting optical compensation values of the first area and the second area by generating a first low voltage profile according to the temperature and luminance of the first area on the basis of the first low voltage and generating a second low voltage profile according to the temperature and luminance of the second area on the basis of the second low voltage.

The optical compensation method may further include storing the optical compensation values in an internal memory of the display device.

It is to be understood that both the foregoing general description and the following detailed description of the present disclosure are exemplary and explanatory and are intended to provide further explanation of the present disclosure.

### BRIEF DESCRIPTION OF THE SEVERAL VIEWS OF THE DRAWINGS

The accompanying drawings, which are included to provide a further understanding of the present disclosure and are incorporated in and constitute a part of this application, illustrate aspect(s) of the present disclosure and together with the description serve to explain the principle of the present disclosure. In the drawings:

FIG. 1 is a block diagram schematically showing a configuration of a display device subject to optical compensation according to an aspect of the present disclosure;

FIG. 2 is a schematic configuration diagram of a subpixel shown in FIG. 1;

FIG. 3 is a diagram for describing a display panel of a display device subject to optical compensation according to an aspect of the present disclosure;

FIGS. 4A, 4B, and 5 are diagrams for describing luminance characteristics for each pixel region of the display panel of the display device of FIG. 3;

FIG. 6 is a control block diagram of an optical compensation system according to an aspect of the present disclosure;

FIG. 7 is a diagram illustrating a schematic configuration when a display device equipped with the optical compensation system according to an aspect of the present disclosure is applied to a smartphone;

FIG. 8 is a flowchart of an optical compensation method according to an aspect of the present disclosure; and

FIG. 9 is a diagram illustrating a VSS profile of the optical compensation system according to an aspect of the present disclosure.

### DETAILED DESCRIPTION

The advantages and features of the present disclosure and the way of attaining the same will become apparent with reference to aspects described below in detail in conjunction with the accompanying drawings. The present disclosure, however, is not limited to the aspects disclosed hereinafter and may be embodied in many different forms. Rather, these exemplary aspects are provided so that this disclosure will be through and complete and will fully convey the scope to those skilled in the art.

The shapes, sizes, ratios, angles, numbers, and the like, which are illustrated in the drawings in order to describe various aspects of the present disclosure, are merely given by way of example, and therefore, the present disclosure is not limited to the illustrations in the drawings.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements. Other expressions that describe the relationship between elements, such as “between” and “immediately between” or “adjacent to” and “directly adjacent to” should be interpreted similarly.

When describing positional relationships, for example, when the positional relationship between two parts is described using “on”, “above”, “below”, “beside”, or the like, one or more other parts may be located between the two parts unless the term “directly” or “closely” is used.

In the present disclosure, it will be understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Unless otherwise defined, all terms including technical and scientific terms used herein have the same meaning as commonly understood by one of ordinary skill in the art to which example aspects belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Meanwhile, if an aspect can be implemented differently, functions or operations specified within a specific block may occur differently from the order specified in a flowchart. For example, two consecutive blocks may actually be performed substantially simultaneously, or the blocks may be performed in reverse depending on functions or operations involved.

Hereinafter, aspects of the present disclosure will be described in detail with reference to the attached drawings. In the following description, if a detailed description of known techniques associated with the present disclosure would unnecessarily obscure the gist of the present disclosure, detailed description thereof will be omitted.

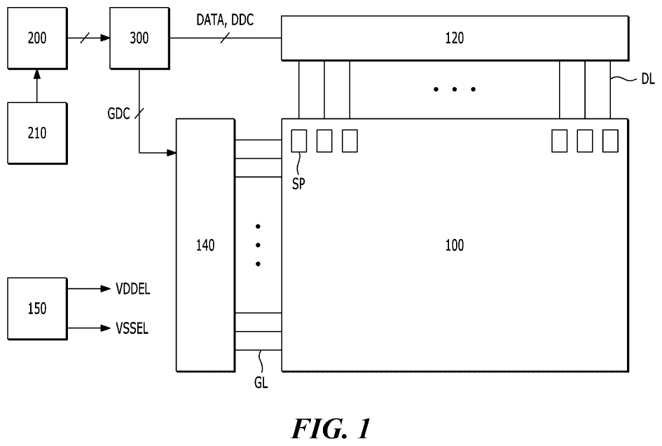

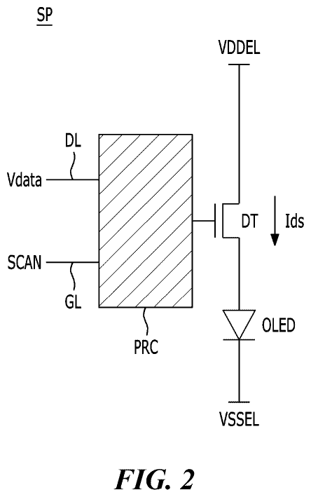

FIG. 1 is a block diagram schematically showing a configuration of a display device subject to optical compensation according to an aspect of the present disclosure, and FIG. 2 is a schematic configuration diagram of a subpixel shown in FIG. 1.

Referring to FIG. 1, the display device may include a host system 200, a display panel 100, a data driver 120, a gate driver 140, a power supply 150, and a timing controller 300.

The host system 200 may be implemented as a variety of systems, such as a television system, a set-top box, a navigation system, a DVD player, a Blu-ray player, a personal computer, a home theater system, and a phone system. The host system 200 converts image data supplied externally or image data stored in an internal memory into a format suitable for the resolution of the display panel 100. The host system 200 may transmit a timing control signal to the timing controller 300 along with image data. The timing control signal may include a vertical synchronization signal, a horizontal synchronization signal, etc., related to image data.

The timing controller 300 generates a data control signal DDC for controlling an operation timing of the data driver 120 and a gate control signal GDC for control an operation timing of the gate driver 140 on the basis of the timing control signal input from the host system 200. The timing controller 300 may provide a data signal DATA supplied from the host system 200 along with the data timing control signal DDC to the data driver 120 and provide the gate control signal GDC to the gate driver 140. The timing controller 300 may be formed in the form of an integrated circuit (IC) and mounted on a printed circuit board, but the present disclosure is not limited thereto.

The data driver 120 may sample and latch the data signal DATA in response to the data timing control signal DDC supplied from the timing controller 300, convert the digital data signal into an analog data voltage on the basis of a gamma reference voltage, and output the analog data voltage. In addition, when a data voltage VDATA is supplied from the timing controller 300, the data driver 120 may provide the data voltage VDATA to subpixels SP included in the display panel 100 through data lines DL. The data driver 120 may be formed as a D-IC and mounted on the display panel 100 or on a printed circuit board, and some or all of the components may be built into the timing controller 300, but the present disclosure is not limited thereto.

The gate driver 140 may output a scan signal in response to the gate timing control signal GDC supplied from the timing controller 300. The gate driver 140 may supply at least one scan signal to the subpixels SP included in the display panel 100 through a gate line GL. The gate driver 140 may be formed in the form of an IC or directly formed on the display panel 100 in a gate-in-panel structure.

The power supply 150 may convert power supplied from the outside into power to drive the display device under the control of the timing controller 300 and output the converted power. For example, the power supply 150 may convert power supplied from the outside into a high voltage VDDEL and a low voltage VSSEL and output the voltages. The power supply 150 may generate and output voltages (e.g., gate voltages including a gate high voltage and a gate low voltage) to drive the gate driver 140 or voltages (drain voltages including a drain voltage and a half-drain voltage) to drive the data driver 120.

The display panel 100 includes a plurality of data lines DL and a plurality of gate lines GL formed to intersect each other, and subpixels SP are disposed in a matrix form at the intersections to form a pixel array.

As shown in FIG. 2, each subpixel SP may include an organic light emitting diode OLED, a driving element DT, and a programming circuit PRC. The organic light emitting diode OLED emits light with brightness proportional to a driving current Ids. The organic light emitting diode OLED may include an organic light emitting layer but is not limited thereto. The programming circuit PRC includes a first switch connected to the data line DL, at least one second switch connected to the gate line GL, and at least one capacitor and sets a gate-source voltage of the driving element DT according to driving conditions.

The driving element DT generates the driving current Ids according to a data voltage Vdata and supplies the driving current to the light emitting element OLED. The low voltage VSSEL may be reflected in the gate-source voltage of the driving element DT, and the high voltage VDDEL may be reflected in the drain-source voltage of the driving element DT. Accordingly, the low voltage VSSEL and the high voltage VDDEL may affect the magnitude of the driving current Ids that determines the luminance of the subpixel SP.

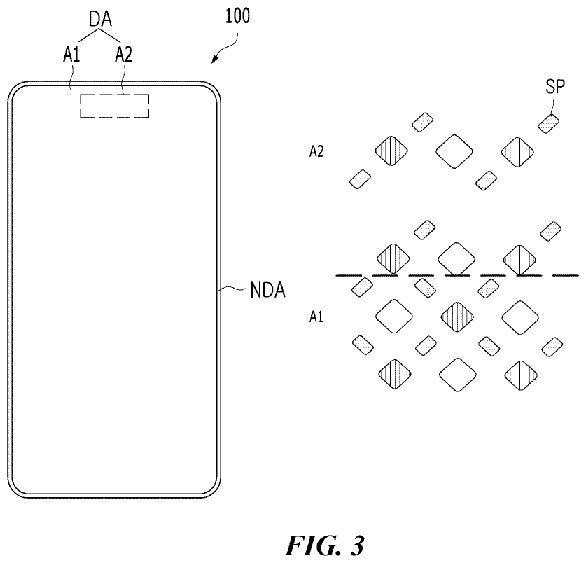

FIG. 3 is a diagram for describing a display panel of a display device subject to optical compensation according to an aspect of the present disclosure.

Referring to FIG. 3, the display panel 100 may include a display area DA in which an image is displayed and a non-display area NDA in which no image is displayed.

The non-display area NDA may be an area outside the display area DA. Various signal lines may be disposed in the non-display area NDA and various driving circuits may be connected thereto. The non-display area NDA is also called a bezel or a bezel area.

A plurality of subpixels SP for displaying an image may be disposed in the display area DA. Here, the display area DA may include a general area A1 and one or more optical areas A2.

The optical area A2 refers to an area where an optical device is disposed. An optical device that receives light that has passed through the display panel 100 and executes a predetermined function according to the received light may be disposed under the optical area A2 (opposite the viewing surface). The optical device may include an imaging device such as a camera, detection sensors such as a proximity sensor, an illuminance sensor, etc.

The optical device is a device that requires light reception, but is located under the display area DA (opposite the viewing surface) and receives the light that has passed through the display panel 100. Therefore, the optical area A2 where the optical device is disposed needs to have both an image display structure and a light transmission structure. That is, since the optical area A2 is a part of the display area DA, subpixels SP for image display need to be disposed, and a light transmission structure for transmitting light to the optical device needs to be formed.

For example, the optical area A2 may include at least one hole. The optical device may be formed overlapping the hole. For example, at least one optical device may be disposed to correspond to at least one hole.

The optical device may not be exposed to the viewing surface of the display panel 100. For example, when a user looks at the viewing surface of the display panel 100, the optical device may not be visible to the user.

Accordingly, the optical area A2 is designed with a structure for increasing light transmittance. The optical area A2 has a structure with a reduced aperture ratio compared to the general area A1, and the general area A1 and the optical area A2 may have different resolutions, subpixel arrangement structures, numbers of pixels per unit area, etc. As a result, the general area A1 and the optical area A2 have differences in optical characteristics, such as luminance characteristics and color coordinate characteristics.

For example, the optical area A2 may have a smaller number of pixels SP per unit area than the general area A1.

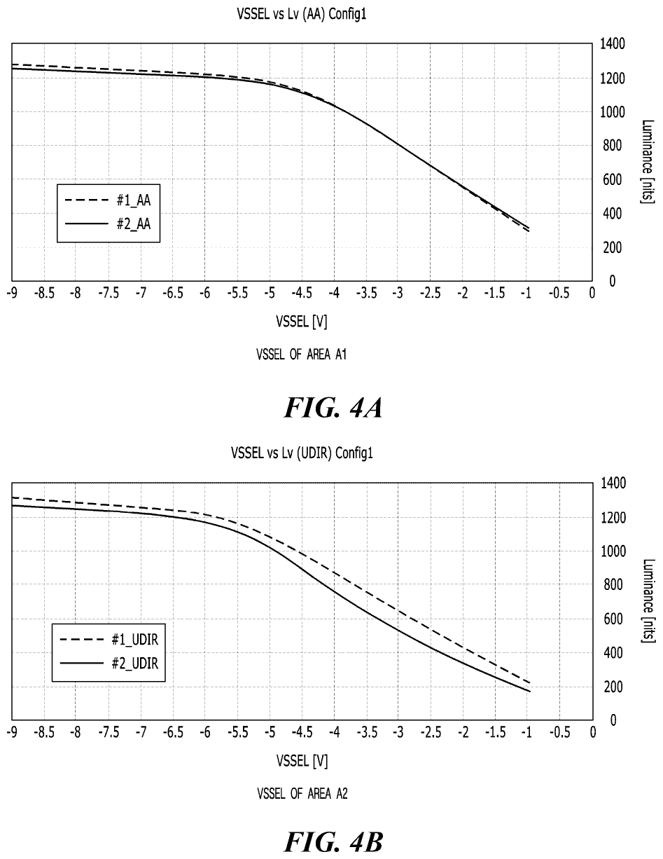

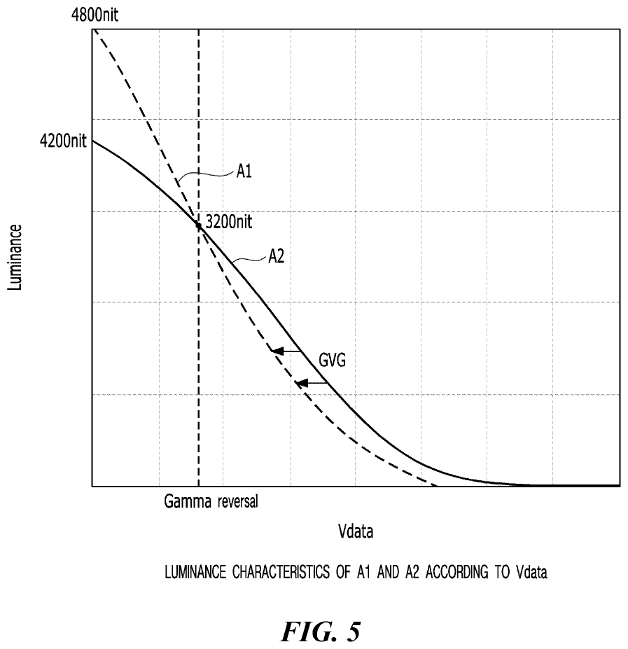

FIGS. 4A, 4B and 5 are diagrams for describing luminance characteristics for each pixel region of the panel of the display device of FIG. 3.

FIG. 4A is a graph showing luminances measured when VSSEL is changed on the basis of the same gamma value in the general area A1. FIG. 4B is a graph showing luminances measured when VSSEL is changed on the basis of the same gamma value in the optical area A2. As shown in FIG. 4A and 4B, it can be ascertained that different luminances are measured when VSSEL is changed in the general area A1 and the optical area A2.

FIG. 5 is a graph showing measured luminance characteristics according to Vdata in the general area A1 and the optical area A2. As shown in FIG. 5, the luminance of the general area A1 changes rapidly depending on Vdata compared to the optical area A2. Accordingly, it is ascertained that as Vdata changes, the luminance of the general area A1 and the luminance of the optical area A2 are reversed.

Since the existing optical compensation system performs optical compensation by applying a single VSSEL to the general area A1 and the optical area A2, it is difficult to compensate for a luminance difference due to a design difference between the general area A1 and the optical area A2. In addition, since the same Vblack (AVREG) is used, different Vdata ranges cannot be applied to the general area A1 and the optical area A2, and thus there are limitations in luminance and color coordinate correction.

Accordingly, in an aspect of the present disclosure, optical compensation is performed by applying different VSSEL, VSSEL profiles, and black voltages Vblack to the general area A1 and the optical area A2. That is, during optical compensation, optical compensation is performed in a state in which different VSSEL, VSSEL profiles, and black voltages Vblack are applied to the general area A1 and the optical area A2, thereby reducing luminance and color coordinate differences due to a design difference between the general area A1 and the optical area A2 and preventing occurrence of optical characteristic differences even if the design changes during a product development process.

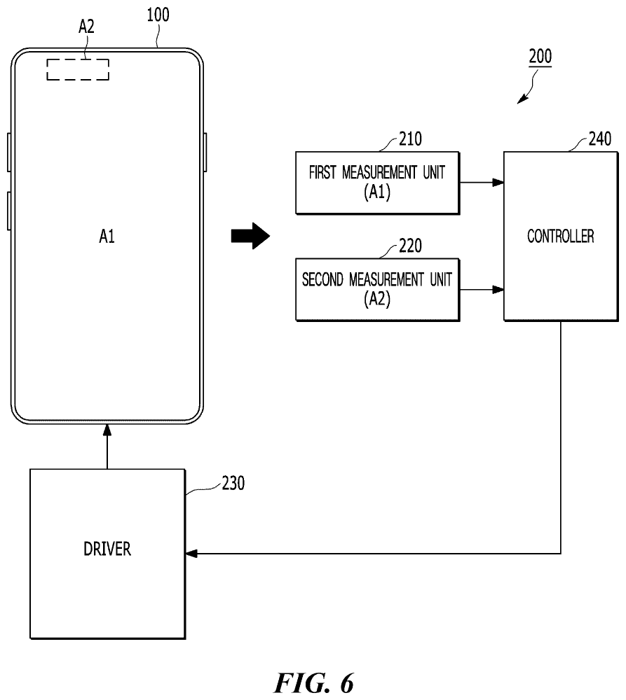

FIG. 6 is a control block diagram of an optical compensation system according to an aspect of the present disclosure.

The optical compensation system according to an aspect of the present disclosure includes a first measurement unit 210, a second measurement unit 220, a driver 230, and a controller 240.

The first measurement unit 210 and the second measurement unit 220 measure optical characteristics (e.g., color coordinates, luminance, etc.) of a specific image displayed on the display device and transmit the obtained optical characteristics of the display device to the controller 240. The first measurement unit 210 may measure the optical characteristics of the general area A1, and the second measurement unit 220 may measure the optical characteristics of the optical area A2. Since the optical area A2 has a very small area compared to the general area A1, a measuring unit is configured to have a small aperture suitable for the area of the optical area A2 in order to accurately measure the optical characteristics of the optical area A2. Accordingly, the aspect of the present disclosure may additionally include the second measurement unit 220 for measuring the optical characteristics of the optical area A2 in addition to the first measurement unit 210 for measuring the optical characteristics of the general area A1.

Each of the measurement units 210 and 220 may include a light quantity sensor (e.g., luminance meter), a color component sensor (e.g., color coordinate system), etc. For measurement of optical characteristics, a specific image displayed on the display panel 100 may correspond to gamma values of gamma adjustment points. Here, the gamma adjustment points may be tap grayscale points of an output gamma string built into the data driver. Additionally, the gamma values of the gamma adjustment points may be gamma register values for controlling the levels of tap gamma voltages (or gamma reference voltages) of the output gamma string. A plurality of gamma adjustment points may be set for each of a low grayscale section, a middle grayscale section, and a high grayscale section.

The driver 230 may apply a control signal to the display device or store data under the control of the controller 240. The driver 230 may display a test pattern on the display panel 100 of the display device under the control of the controller 240. Here, the driver 230 may display the test pattern by applying different VSSEL, VSSEL profiles, and black voltages Vblack to the general area A1 and the optical area A2 under the control of the controller 240. The driver 230 may store optical compensation values calculated by the controller 240 in a memory built into the display device. Accordingly, the display device for which compensation has been completed can display an image that matches target color coordinates and target luminance according to the compensation values stored in the memory.

The controller 240 may control the driver 230 to display a test image on the display panel 100, measure color coordinates and luminances of the general area A1 and the optical area A2 through the first measurement unit 210 and the second measurement unit 220, and generate optical compensation values for the general area A1 and the optical area A2 according to the measurement results. The controller 240 may simultaneously drive the first measurement unit 210 and the second measurement unit 220 to simultaneously perform optical compensation for the areas A1 and A2. Since optical compensation is performed by measuring optical characteristics of the optical area A2, which has a very narrow area compared to the general area A1, using the second measurement unit 220 with a small aperture, compensation accuracy can be improved.

In order to generate optical compensation values, the controller 240 first optimizes voltages VSSEL of the general area A1 and the optical area A2, applies an optimized VSSEL profile for each area, and sets Var (initialization voltage) according thereto. Since the general area A1 and the optical area A2 have different black voltage (Vblack) characteristics due to differences in the design of the subpixels, the black voltage Vblack is optimized and set for each area.

The controller 240 optimizes the VSSEL and VSSEL profiles and black voltages Vblack of the general area A1 and the optical area A2, and then generates optical characteristic compensation values according to measured color coordinates and luminances transmitted from the measurement units 210 and 220. The generated compensation values may be stored in the memory in the display device, for example, in a built-in memory of the D-IC for data driving, through the driver 230.

As described above, before performing optical compensation, the controller 240 optimizes the VSSEL, VSSEL profiles, and black voltages Vblack of the general area A1 and the optical area A2, and then performs optical compensation, and thus compensation accuracy can be improved. When optical compensation is performed using the above-described compensation method, VSSEL and a compensation value are generated in each of the general area A1 and the optical area A2, and optical compensation values can be applied to the areas A1 and A2. The display device completed through the above-described compensation process may be connected to the host system (200 in FIG. 1) and display an image. The host system (200 in FIG. 1) may be implemented as a variety of systems, such as a smartphone, a television, a set-top box, a navigation system, a DVD player, a Blu-ray player, a personal computer, and a home theater system.

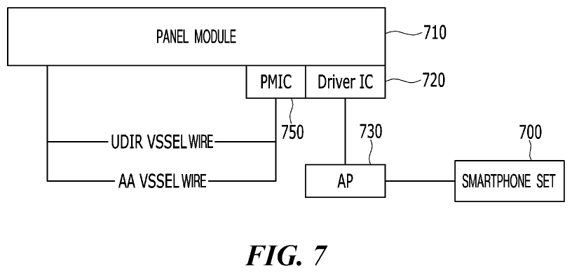

FIG. 7 is a diagram illustrating a schematic configuration when a display device equipped with the optical compensation system according to an aspect of the present disclosure is applied to a smartphone.

Referring to FIG. 7, the smartphone may include a smartphone set 700 for implementing smartphone functions, an application processor (AP) 730 for processing a display function, a panel module 710, a driver IC 720 that applies an image data signal to the panel module 710, and a power IC (PMIC) 750 that applies a driving voltage to the panel module 710. Here, the panel module 710 may include an active area (AA) corresponding to the general area A1, and an under display IR sensor (UDIR) area corresponding to the optical area A2.

In the display device to which the optical compensation system according to an aspect of the present disclosure is applied, VSSEL and a compensation value are generated in each of the general area A1 and the optical area A2, and optical compensation values corresponding to the areas A1 and A2 may be applied. Accordingly, a VSSEL wire connected from the power IC (PMIC) 750 to the panel module 710 may be divided into an AA VSSEL wire and a UDIR VSSEL wire.

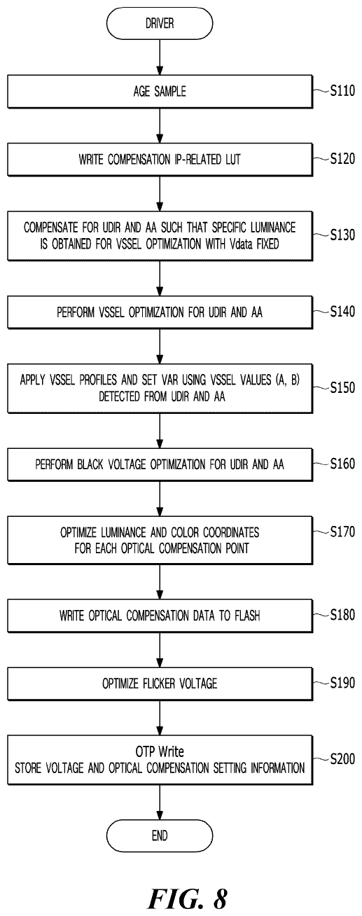

FIG. 8 is a flowchart of an optical compensation method according to an aspect of the present disclosure.

When optical compensation starts, the controller 240 controls the driver 230 to age a display device to be tested (S110). Aging means operating the display device to be tested at a specific luminance for a specific period of time in order to stabilize characteristics thereof.

A compensation IP-related lookup table (LUT) is generated (S120). The compensation IP-related LUT may include information such as HLA (HiAA partial compensation), IRA (IR drop compensation), and HXT (horizontal crosstalk).

For the active area AA, which is the general area A1, and the under display IR sensor (UDIR) area, which is the optical area A2, compensation for adjusting VSSEL of each area is performed such that a preset luminance is detected with Vdata fixed (S130). The controller 240 may simultaneously drive the first measurement unit 210 and the second measurement unit 220 to measure the luminance of each of the AA and the UDIR area and adjust VSSEL of each of the AA and the UDIR area. Since the AA and the UDIR area have different subpixel structures, optimized voltages VSSEL of the two areas may be detected differently.

The controller 240 detects VSSEL at which a preset luminance is detected in each of the AA and the UDIR area and optimizes the VSSEL in each of the AA and the UDIR area (S140).

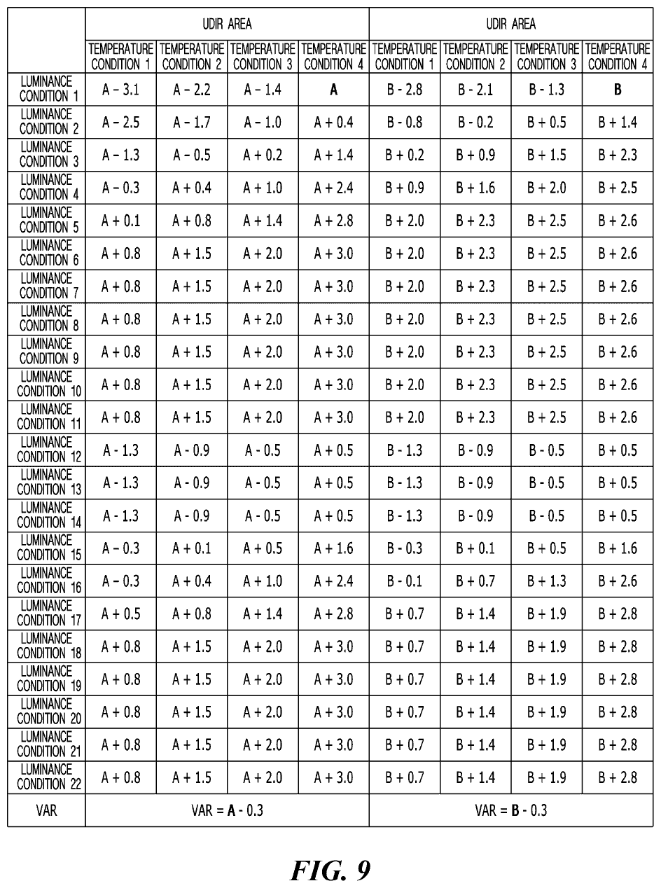

When a VSSEL optimization value A in the UDIR area and a VSSEL optimization value B in the AA are detected, corresponding VSSEL profiles and VAR are set using the optimization values A and B (S150). FIG. 9 illustrates a table for VSSEL profile and VAR settings. As shown in FIG. 9, the VSSEL profile may include luminance condition information set for different temperature conditions. VAR setting can be set to A-0.3 in the UDIR area and set to B-0.3 in the AA. According to the VSSEL profile, if a luminance condition is 1 and a temperature condition is 4, for example, the VSSEL optimization value in the UDIR area may be set to AV and the VSSEL optimization value in the AA may be set to BV. For example, if the luminance condition is 10 and the temperature condition is 2, the VSSEL optimization value in the UDIR area may be set to A+1.5 V and the VSSEL optimization value in the AA may be set to B+2.3 V.

When the VSSEL and VAR in each of the UDIR area and the AA is set, optimization of the black voltage Vblack is performed for each area (S160). Since the AA and the UDIR area have different subpixel structures, different optimized black voltages Vblack may be detected for the two areas. Accordingly, after optimizing the VSSEL and VAR of the two areas, the optimized black voltages Vblack of the two areas are detected.

Thereafter, optical compensation values for optimizing the luminance and color coordinates are detected by controlling RGB Vdata while outputting luminance and color coordinate optimization patterns for each optical compensation point (S170).

The detected optical compensation values are stored in a flash memory (S180). Here, interpolation may be performed on the luminance and color coordinates detected at optical compensation points to calculate continuous compensation values and then the compensation values may be stored.

Upon completion of optical compensation, a flicker voltage may also be compensated and optimized (S190). Flicker voltage compensation compensates for a voltage such that flicker does not occur even during driving at a frequency other than a specific frequency (for example, 120 Hz).

The obtained voltage values and optical compensation values are stored in the internal memory of the display device (S200).

Thereafter, optical compensation may be completed by driving the display device according to the values stored in the internal memory of the display device and checking the optical characteristics for each test pattern. When the display device that has undergone optical compensation through the above-described process is used, different VSSEL voltages and black voltages may be applied to the UDIR area and the AA. Therefore, it is possible to check whether the aspect of the present disclosure is applied by measuring voltages applied to the UDIR area and the AA in the finished product state.

According to aspects of the present disclosure, during optical compensation of a display panel including a plurality of pixel regions with different subpixel arrangements within a display area, the accuracy of measured data can be improved by measuring luminance and color coordinates using a plurality of measuring instruments suitable for characteristics of respective pixel regions and performing compensation. In addition, according to aspects of the present disclosure, during optical compensation of a display panel including a plurality of pixel regions with different subpixel arrangements within a display area, the accuracy of optical compensation can be improved by applying different VSS voltages and black voltages Vblack depending on the characteristics of the respective pixel regions. Furthermore, according to aspects of the present disclosure, optical compensation such as compensation of luminance and color coordinates can be performed by applying different VSS voltages and black voltages Vblack depending on the characteristics of the respective pixel regions, and thus it is possible to prevent occurrence of differences in optical characteristics even if the design changes during a product development process.

Aspects of the present disclosure have the following effects.

According to aspects of the present disclosure, it is possible to provide an optical compensation system and method capable of improving the accuracy of optical compensation by compensating for each pixel region using a plurality of measuring instruments suitable for characteristics of a plurality of pixel regions during optical compensation of a display panel including the plurality of pixel regions with different optical characteristics within a display area.

According to aspects of the present disclosure, it is possible to provide an optical compensation system and method capable of improving the accuracy of optical compensation by applying different VSS voltages and black voltages Vblack depending on characteristics of a plurality of pixel regions during optical compensation of a display panel including the plurality of pixel regions with different subpixel arrangements in a display area.

In addition, according to aspects of the present disclosure, it is possible to prevent occurrence of differences in optical characteristics even if the design changes during a product development process by applying different VSS voltages and black voltages Vblack depending on characteristics of respective pixel regions to achieve optical compensation of luminance, color coordinates, and the like.

The effects according to the present disclosure are not limited to the above-described effects, and various other effects are included within the present disclosure.

Although aspects of the present disclosure have been described in more detail with reference to the accompanying drawings, the present disclosure is not necessarily limited to these aspects, and various modifications may be made without departing from the technical spirit of the present disclosure. Accordingly, the aspects disclosed in the present disclosure are not intended to limit the technical idea of the present disclosure, but rather to explain the technical idea, and the scope of the technical idea of the present disclosure is not limited by these aspects. Therefore, the aspects described above should be understood in all respects as illustrative and not restrictive. The scope of the present disclosure should be interpreted to include those of the claims, and all technical ideas within the equivalent scope should be interpreted as being included in the scope of the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An optical compensation system comprising:
a display device including a plurality of pixels configured to emit light by controlling a driving current flowing from a high voltage to a low voltage according to a data voltage;
a first measurement unit configured to measure optical characteristics from an image displayed in a first area of the display device;
a second measurement unit configured to measure optical characteristics from an image displayed in a second area of the display device;
a driver configured to control at least one of the data voltage, the high voltage, and the low voltage of the display device to display an image; and
a controller configured to detect a first low voltage optimized for pixels in the first area and a second low voltage optimized for pixels in the second area on the basis of optical characteristics input to the first measurement unit and the second measurement unit and to detect optical compensation values on the basis of an image displayed by supplying the first low voltage to the pixels in the first area and by supplying the second low voltage to the pixels in the second area.

2. The optical compensation system of claim 1, wherein the first area includes a general area having a general subpixel arrangement, and the second area includes an optical area in which a transmission part for an optical device is formed.

3. The optical compensation system of claim 1, wherein the controller is configured to detect black data values by supplying the first low voltage to the pixels in the first area and supplying the second low voltage to the pixels in the second area, and then to detect optical compensation values of the first area and the second area.

4. The optical compensation system of claim 1, wherein the controller is configured to supply a fixed data voltage to the first area and the second area, adjust the low voltage applied to the first area and the low voltage applied to the second area, and detect low voltages at which preset luminance is measured in the areas as the first low voltage and the second low voltage.

5. The optical compensation system of claim 4, wherein the controller is configured to detect the optical compensation values by setting an initialization voltage (VAR) of the first area on the basis of the first low voltage and setting an initialization voltage (VAR) of the second area on the basis of the second low voltage.

6. The optical compensation system of claim 4, wherein the controller is configured to detect the optical compensation values of the first area and the second area by generating a first low voltage profile according to the temperature and luminance of the first area on the basis of the first low voltage and generating a second low voltage profile according to the temperature and luminance of the second area on the basis of the second low voltage.

7. The optical compensation system of claim 1, wherein the controller is configured to store the optical compensation values in an internal memory of the display device through the driver.

8. The optical compensation system of claim 1, wherein the second area includes an optical area in which a transmission part for an optical device is formed, and the second measurement unit has an aperture small enough to measure optical characteristics of the second area.

9. An optical compensation method for a display device including a plurality of pixels configured to emit light by controlling a driving current flowing from a high voltage to a low voltage according to a data voltage, the optical compensation method comprising:
measuring optical characteristics of a first area having a general subpixel arrangement in the display device through a first measurement unit, and simultaneously measuring optical characteristics of a second area including an optical area through a second measurement unit;
detecting a first low voltage optimized for pixels in the first area and a second low voltage optimized for pixels in the second area on the basis of optical characteristics input to the first measurement unit and the second measurement unit; and
detecting optical compensation values on the basis of an image displayed by supplying the first low voltage to the pixels in the first area and supplying the second low voltage to the pixels in the second area.

10. The optical compensation method of claim 9, further comprising detecting black data values by supplying the first low voltage to the pixels in the first area and supplying the second low voltage to the pixels in the second area.

11. The optical compensation method of claim 9, wherein the detecting a first low voltage optimized for pixels in the first area and a second low voltage optimized for pixels in the second area comprises supplying a fixed data voltage to the first area and the second area, adjusting the low voltage applied to the first area and the low voltage applied to the second area, and detecting low voltages at which preset luminance is measured in the areas as the first low voltage and the second low voltage.

12. The optical compensation method of claim 11, comprising detecting the optical compensation values by setting an initialization voltage (VAR) of the first area on the basis of the first low voltage and setting an initialization voltage (VAR) of the second area on the basis of the second low voltage.

13. The optical compensation method of claim 11, wherein the detecting optical compensation values on the basis of an image displayed by supplying the first low voltage to the pixels in the first area and supplying the second low voltage to the pixels in the second area comprises detecting optical compensation values of the first area and the second area by generating a first low voltage profile according to the temperature and luminance of the first area on the basis of the first low voltage and generating a second low voltage profile according to the temperature and luminance of the second area on the basis of the second low voltage.

14. The optical compensation method of claim 9, further comprising storing the optical compensation values in an internal memory of the display device.
